(19) United States
(12) Patent Application Publication
(10) Pub. No.: US 2007/0127935 A1
(43) Pub. Date: Jun. 7, 2007

(54) IMAGE FORMING APPARATUS TO WHICH CARTRIDGES ARE DETACHABLY MOUNTABLE

(75) Inventors: Satoru Inami, Numazu-shi (JP); Nobuyoshi Yoshida, Shizuoka-ken (JP); Daisuke Baba, Mishima-shi (JP); Nobuo Komiya, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/565,262

(22) Filed: Nov. 30, 2006

(30) Foreign Application Priority Data
Nov. 30, 2005 (JP) 2005-347150

(51) Int. Cl. G03G 15/00; G03G 15/06

(52) U.S. Cl. 399/12; 399/55

(57) ABSTRACT

An image forming apparatus includes an image bearing member including a first photosensitive layer having a first thickness provided in a first cartridge detachably mountable to a main assembly of the image forming apparatus or including a second photosensitive layer having a second thickness provided in a second cartridge detachably mountable to the main assembly of the image forming apparatus; a developer carrying member for carrying a developer to develop with a developer an electrostatic image formed on the image bearing member; a voltage source for applying a development DC voltage to the developer carrying member; a density changing device for changing a density of the image by changing the development DC voltage, wherein when the density changing device changes a density set level from a standard value to a changed value, an amount of the change of the development DC voltage is different between when the first cartridge is used and when the second cartridge is used.

### FIELD OF THE INVENTION

The present invention relates to an image forming apparatus to which cartridges are detachably mountable.

The image forming apparatus may be an electrophotographic copying machine, an electrophotographic printer (LED printer, laser beam printer or the like), an electrophotographic printer type facsimile machine and so on.

The cartridge detachably mountable to the main assembly of the electrophotographic image forming apparatus preferably comprises an electrophotographic photosensitive member (image bearing member) and at least a part of electrophotographic image forming process means actable on the electrophotographic photosensitive member. For example, the process means may be charging means for charging the electrophotographic photosensitive member, developing means for supplying the developer to the electrophotographic photosensitive member, cleaning means for cleaning the electrophotographic photosensitive member.

### DESCRIPTION OF THE RELATED ART

In the field of an image forming apparatus using an electrophotographic image forming process, a cartridge type is known wherein the electrophotographic photosensitive member and the process means actable on the electrophotographic photosensitive member are unified into a cartridge, which is detachably mountable to the main assembly of the image forming apparatus.

With the cartridge type, the maintenance operation can be performed by the user without relying on a service person, and in that sense, the operativity is improved. Therefore, the cartridge type is widely used in the field of electrophotographic image forming apparatus.

Recently, because of the widely use of computers, a wider range of people use printers, copying machines and facsimile machines.

Under the circumstances, it is desired that main assembly of the image forming apparatus is capable of operating with an plurality of kinds of cartridges having different amount of toner (lifetime of the cartridge), the cartridges being consumable products for the printers, the copying machines, facsimile machines and so on. Then, the user in an office or the like with which the print volume is large can use large toner capacity cartridges having a long lifetime. On the other hand, a personal user with which the print volume is small can use small toner capacity cartridges having a short lifetime. The user can use a desired one of the cartridges with the same type of the main assembly of the image forming apparatus.

In many cases, the electrophotographic image forming apparatus automatically presets the image density of the output image at a predetermined standard value density setting (default setting) using control means of the image forming apparatus. The user can change the setting to obtain a desired density, line thickness, for example.

Referring first to FIG. 11, for example, the user can manually change a development DC voltage to change the development contrast (potential difference between the development DC voltage and the image portion potential of the electrostatic latent image (light portion potential), thus effecting the density adjustment. When a density higher than the default setting is desired, the development DC voltage is changed toward an upper limit in FIG. 11, and when a lower density is desired, the development DC voltage is changed toward a lower limit.

On the other hand, a proposal has been made in which the cartridge is provided with memory (memory medium) (storing means), and the memory stores information relating to the nature of the cartridge, wherein the image quality is stabilized irrespective of the state of use of the cartridge on the basis of the stored information, for the purpose of quality control of the cartridge.

For example, U.S. Pat. No. 5,272,503 discloses an image forming apparatus in which the number of prints (copies) is integrated and is stored as the use amount of the cartridge in a memory element of the main assembly of the image forming apparatus, and a process condition (image forming condition) is controlled on the basis of the integrated value of the number of produced prints.

As another example, Japanese Laid-open Patent Application Hei 08-146677, Japanese Laid-open Patent Application Hei 10-246994 and Japanese Laid-open Patent Application Hei 11-015214 propose various methods to accomplish stabilization of the image quality.

Japanese Laid-open Patent Application Hei 08-146677, Japanese Laid-open Patent Application Hei 10-246994 and Japanese Laid-open Patent Application Hei 11-015214 disclose an image forming apparatus wherein a charging bias voltage applied to charging means and a developing bias applied to developing means are switched in accordance with decrease of a thickness (film thickness) of the photosensitive layer of the photosensitive member, so that change in the image quality attributable to the change of the film thickness of the photosensitive layer.

Japanese Patent No. 3285785, for example, proposes a method with which the degree of use of the photosensitive member can be determined with high precision. More particularly, rotation time information of the photosensitive member and application time information of a charging bias applied to the charging means for charging the photosensitive member are integrated, and the integrated value are stored in a memory element provided in the cartridge, wherein the use amount of the photosensitive member is calculated with high precision.

However, in the case of the cartridges having different toner capacities (lifetimes) and mountable to the main assembly of the image forming apparatus, the film thicknesses of the photosensitive layers of the photosensitive members are different in many cases, since the film thicknesses are selected to be optimum in view of the toner capacities (lifetimes).

Different film thicknesses of the photosensitive layers mean different latent image properties (charging properties) on the photosensitive members. It has been found that even if the default settings of the process conditions (image forming conditions such as developing conditions) are the same, the same densities or line widths are not provided when the center setting of the density is changed manually, if the cartridges and the film thicknesses of the photosensitive layers are different.

More particularly, in an S cartridge having a short lifetime (a small thickness photosensitive layer and a small toner capacity) and in an L cartridge having a length lifetime (a large thickness photosensitive layer and a large toner capacity), the settings are such that four-dot line width (600 dpi) is printed substantially equally in 180 μm thick, in the default settings.

When the density setting is changed to the upper limit on the operation panel of the printer (image forming apparatus), the line width becomes 215 μm, for example, in the case of the L cartridge. However, in the S cartridge case, the line width becomes 200 μm, for example, in some cases.

On the other hand, the image density can vary depending on difference in the history of use of the cartridge even if a single kind of cartridges is used. Particularly, the image density may vary depending on difference in the use history, when the user changes the density setting.

### SUMMARY OF THE INVENTION:

Accordingly, it is a principal object of the present invention to provide an image forming apparatus and a process cartridge wherein even when a plurality of kinds of cartridges comprising image bearing members having photosensitive layers having different thicknesses are used selectively with the same image forming apparatus, stabilized image quality can be provided irrespective of the kind of the cartridge.

It is another object of the present invention to provide an image forming apparatus and a process cartridge wherein variations of image densities attributable to the difference in the use history of the cartridge is suppressed, so that stabilized image quality can be assured.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS:

FIG. 1 shows a general arrangement of an image forming apparatus according to Embodiment 1 of the present invention.

FIG. 2 is a partial enlarged view of the image forming apparatus of FIG. 1.

FIG. 3 is a block diagram of a control system.

FIG. 4 shows a property of a light portion potential depending on difference of a film thickness of a photosensitive layer.

FIG. 5 is a graph illustrating a difference of the line widths in the upper and lower limit settings of density in a conventional S cartridge and a conventional L cartridge.

FIG. 6 shows a setting of developing bias DC voltage for the center setting on the density in the S cartridge and in the L cartridge.

FIG. 7 is a graph of the line width for the center setting of the density.

FIG. 8 shows a property of a light portion potential when the sensitivity of the drum is the same.

FIG. 9A is a flow chart showing a process controlling operation in the apparatus according to Embodiment 2 of the present invention.

FIG. 9B is a flow chart showing a process controlling operation in the apparatus according to Embodiment 2 of the present invention.

FIG. 10 is a graph of change of the line widths in the upper and lower limit settings of the density relative to the number of printed sheets.

FIG. 11 illustrates the case that center setting of the density can be changed by the DC voltage.

### DESCRIPTION OF THE PREFERRED EMBODIMENTS

Referring to the accompanying drawings, the preferred embodiments of the present invention will be described.

### Embodiment 1

(1) General Arrangement of Image Forming Apparatus:

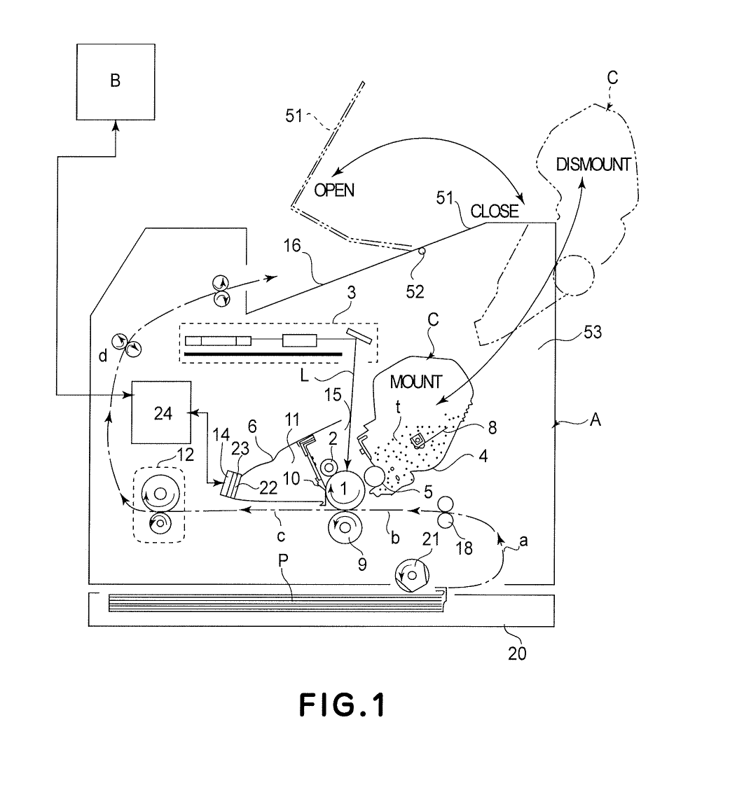

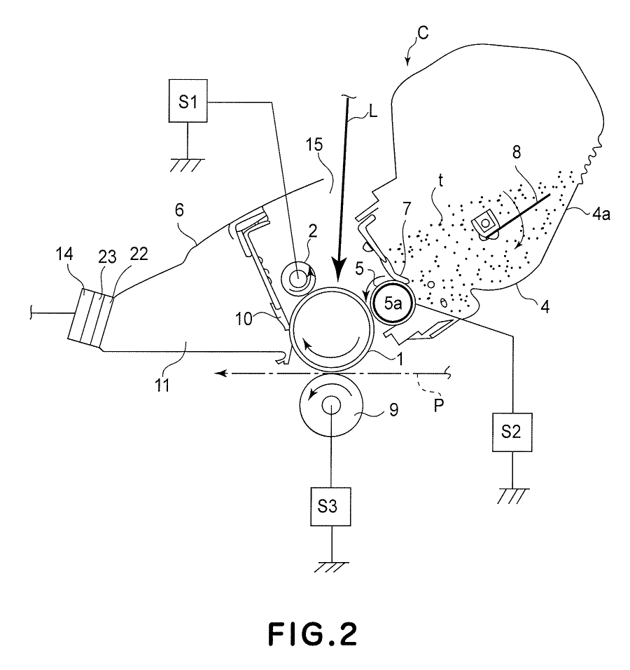

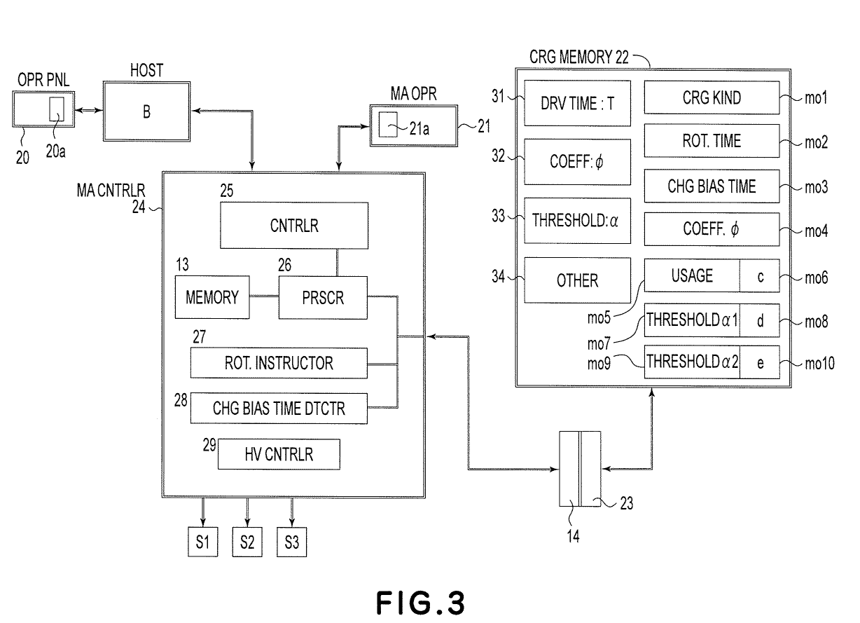

FIG. 1 is a schematic view of an image forming apparatus according to this embodiment of the present invention; FIG. 2 is a partial enlarged view thereof; and FIG. 3 is a block diagram of a control system of the image forming apparatus.

The image forming apparatus is a process cartridge mounting type laser beam printer using an electrophotographic process, and is connected with a host computer B by a LAN cable, so that it receives image information from the host computer B and outputs image prints.

Designated by A is a main assembly of the printing apparatus, and designated by C is a process cartridge (cartridge) detachably mountable to the main assembly of the apparatus. In the description, a widthwise direction of the cartridge is a direction in which the cartridge is mounted to and demounted from the main assembly of the apparatus, and a longitudinal direction of the cartridge is a direction crossing with the widthwise directing direction. A front side of the cartridge is the trailing end side when the cartridge is inserted into the main assembly of the apparatus (righthand side in FIG. 1), a rear side (left side in FIG. 1) is the leading end side. An upper side is the side which faces up when the cartridge is set in the main assembly of the apparatus, and a lower side is the side which faces down.

The cartridge comprises an electrophotographic photosensitive member (image bearing member), process means and a consumable material such as developer and is detachably mountable relative to the main assembly A of the apparatus. The cartridge C of this embodiment includes a cylindrical electrophotographic photosensitive member drum 1 (image bearing member). The process means, in this embodiment, includes a charging roller 2 (contact charging member) in the form of a charger for charging uniformly the surface of the drum 1, developing device 4 (toner developing means) for developing an electrostatic latent image on the drum, and cleaning device 6 (cleaning means) for cleaning the surface of the drum after the developed image is transferred from the photosensitive drum.

When the cartridge C is mounted to or demounted from the main assembly A of the apparatus, an opening and closing cover 51 provided at the upper portion is opened, about a hinge portion 52 as indicated by point chain lines. When the cover 51 is opened, a cartridge mounting portion 53 in the main assembly A of the apparatus is seen. Left and right walls of the mounting portion are provided with guiding rails (unshown) inclined down toward the rear side of the apparatus, as seen through the opening. The cartridge C is inserted into the mounting portion 53 with the front side gripped by hand. The cartridge is provided at each of left and right sides with a positioning boss (unshown) projecting outwardly on the axis of the drum 1, and is provided, at a position behind each of the positioning bosses with respect to the cartridge mounting direction, with a rotation preventing guide (unshown). The bosses and guides are engaged with the guide rails. The cartridge C is fully inserted to engage the positioning boss with a positioning groove (unshown) of the main assembly side of the apparatus, thus mounting the cartridge C to the predetermined position in the main assembly side of the apparatus A. In the predetermined mounting position, an exposure opening 15 formed in the upper surface of the cartridge faces a laser beam scanner (scanner) 3 of the main assembly of the apparatus. A lower surface of the drum exposed at the lower surface of the cartridge is faced and contacted to the transfer roller 9. Then, the cover 51 is closed.

By the mounting of the cartridge C to the predetermined position in the main assembly A of the apparatus, the cartridge C is mechanically and electrically coupled with the main assembly A of the apparatus. By this, a driven member or driven members (for the drum, the developing roller, the toner stirring member or the like) can be driven by a driving mechanism of the main assembly A of the apparatus. Various sensors of the cartridge C are electrically connected with a main assembly controller 24 of the main assembly A of the apparatus. The predetermined bias voltage can be applied from a high voltage source of the main assembly A of the apparatus to the charging roller and the developing roller of the cartridge C.

The cartridge C is dismounted from the main assembly A of the apparatus through the reverse steps. In FIG. 1, the cover 51 is opened, and the cartridge C is pulled out toward upper right. Then, the cartridge C is guided by the guiding rails to the outside of the main assembly A of the apparatus.

When the cartridge C is taken out of the main assembly A of the apparatus, the drum shutter (unshown) is at the position covering the lower surface of the drum 1 to protect the lower surface of the drum. The drum shutter is moved to the opening position during movement of the cartridge C into the main assembly A of the apparatus. When the cartridge C is taken out of the main assembly A of the apparatus, the shutter (unshown) moves to the closing position for closing the exposure opening 15. The exposure shutter moves to the opening position to open the exposure opening 15 during the mounting movement of the cartridge C to the main assembly A of the apparatus.

The main assembly controller (control means) 24 exchanges information with the host computer B to control the image formation sequence control for the printer. Print start signal causes the main assembly controller 24 to execute the image forming operation by the printer. More particularly, the driving motor (unshown) is started to rotate the drum 1 in the clockwise direction indicated by an arrow at a predetermined speed.

A peripheral surface of the rotated drum 1 is charged uniformly by the charging roller 2 to a predetermined polarity. The charging roller 2 comprises a core metal and an elastic electroconductive member on the surface thereof, and the opposite ends of the core metal are supported rotatably. It is press-contacted to the outer surface of the drum 1 with a predetermined urging force. The charging roller 2 is supplied with a superimposed voltage (Vac+Vdc), which includes a DC component Vdc and an AC component Vac having a peak-to-peak voltage Vpp not less than twice the charging starting voltage of the drum through the core metal from the high voltage source (bias supplying voltage source) provided in the main assembly of the apparatus. By this, the outer surface of the rotated drum 1 is uniformly charged. In this example, the drum 1 is charged to the negative predetermined potential.

The charged surface of the drum 1 is exposed to the laser scanning light by the scanner 3 so that electrostatic latent image is formed correspondingly to the image information. The scanner 3 comprises a semiconductor laser, a polygonal mirror and a F-f [symbol] , and functions to output a laser beam L modulated in accordance with a time series electrical digital pixel signal indicative of the image information inputted to the main assembly controller 24 from the host computer B. The laser beam L enters the cartridge through the exposure opening 15 formed in the upper surface of the cartridge and scans the surface of the drum. The potential of the surface portion of the drum (light portion) which is illuminated with the laser beam attenuates so that electrostatic latent image is formed on the drum surface correspondingly to the image information.

The electrostatic latent image is visualized into a toner image by the developing device 4 with the toner (developer) t. The developing method may be a so-called jumping developing method or two component developing method or the like. In the case of the printer, a combination of the image portion exposure and the reverse development is used in most cases. In this embodiment, the image portion exposure with which the image portion to receive the toner is exposed to the light is used, by which an electrostatic latent image is formed. The electrostatic latent image is developed through a reverse development by the developing device of the jumping development type with negative chargeable magnetic one component toner (negative charged toner).

In the developing device 4, designated by 5 is a developing sleeve (developer carrying member) disposed opposed to the drum 1. It comprises a non-magnetic aluminum sleeve and a resin material layer. In the developing sleeve 5, there is provided a magnet roller 5a having four magnetic poles. The developing sleeve 5 is rotated in the counterclockwise direction indicated by an arrow at a predetermined speed. Designated by 4a is a toner container 4a (developer accommodating portion) accommodating the negative chargeable magnetic one component toner t (developer). In the toner container 4a, there is provided a toner stirring member 8 rotatable clockwise direction indicated by an arrow to stir the toner in the toner container 4a, thereby to feed the toner to the developing sleeve 5 while loosening the toner. The magnetic one component toner t is attracted magnetically by the magnetic force of the magnet roller 5a on the peripheral surface of the developing sleeve 5 and is fed by the rotation of the developing sleeve 5. The toner is subjected to the triboelectric charging and regulating operation by passing through the nip formed between the developing sleeve 5 and a developer regulating member 7 elastically contacted to the developing sleeve 5, by which a proper coating amount is provided on the developing sleeve 5, and the toner is triboelectrically charged to the negative polarity. The toner is carried on the developing sleeve 5 to the developing zone where the developing sleeve 5 is opposed to the drum 1. The developing sleeve 5 is supplied with a predetermined developing bias from the high voltage source of the main assembly of the apparatus. The developing bias is a superimposed voltage of a DC voltage (DC bias) and an AC voltage (AC bias) in the form of a rectangular wave, for example.

On the other hand, the main assembly controller 24 rotates the sheet feeding roller 21 at predetermined control timing through one full turn. By this, the top one of the recording materials (transfer materials) P stacked in the sheet feeding cassette 20 is picked up and fed out. The transfer material P is fed along a sheet path a to a nip formed between a pair of registration rollers which is on-off-controlled at predetermined control timing. The pair of registration rollers 18, which are at rest, receives and temporarily stops the leading end of the transfer material P to correct the obliqueness of the sheet feed. The pair of registration rollers 18 are rotated at predetermined control timing to introduce the transfer material P along a sheet path b to a transfer nip where the transfer roller 9 is contacted to the drum 1. More particularly, the transfer material P is fed to the transfer nip in synchronism with the toner image on the drum 1 by the registration roller 18. During the transfer material P passing through the transfer nip, the transfer roller 9 is supplied with a transfer bias of a predetermined potential of the polarity (positive in this embodiment) opposite from the charge polarity of the toner from the high voltage source S3. By this, the toner image on the surface of the drum 1 is electrostatically transferred onto the transfer material P sequentially.

The transfer material P departing from the transfer nip is separated from the surface of the drum 1 and is introduced into the fixing device (fixing means) 12 along a sheet path c.

On the other hand, the surface of the drum 1 after separation of the transfer material is cleaned by a cleaning blade 10 of the cleaning device 6 which is effective to remove the remaining deposited matter such as untransferred toner to prepare the drum for repeated image forming operation. The untransferred toner or the like removed from the surface of the drum by the cleaning blade 10 is accommodated in a residual toner container 11.

The transfer material P introduced in the fixing device 12 is heated and pressed an unfixed toner image is fixed onto the transfer material into a permanent fixed image. It is discharged to the sheet discharge tray 16 at the upper surface of the main assembly of the apparatus.

(2) Discriminating Means for Discriminating Kind of Mounted Cartridge:

The main assembly A of the image forming apparatus of this embodiment is selectively usable with any one of different kinds of cartridges which contain drums having different thickness photosensitive layers and which have different toner capacities. Such different kinds of cartridges are prepared by a manufacturer.

The main assembly A of the apparatus is provided with discrimination means for discriminating the kinds of the cartridges mounted to the main assembly A of the apparatus, more particularly, detecting means for individual cartridge type discrimination of the cartridge mounted to the main assembly A of the apparatus. Examples of such detecting means are:

1. Discriminative information such as bar-code stuck on the cartridge at a predetermined position and is illuminated by light from a detecting light source provided in the main assembly of the apparatus, and the light reflected thereby is read by a detector such as a photo-diode or the like;

2. The cartridge is provided with a plurality of operating fingers which can actuate micro-switches provided in the main assembly of the apparatus;

3. The cartridge is provided with an electric circuit, and a resistance of the circuit, which is peculiar to the kind of the cartridge, is discriminated; and

4. The cartridge is provided with storing means (memory medium) (memory), and the discriminative information stored in the memory is read to discriminate the information.

In this embodiment, the fourth example is employed. The cartridge C is provided on a rear side with a memory 22 and a cartridge side transmitting portion 23 for controlling the information reading and writing operation for the memory 22. The memory 22 and the transmitting portion 23 are unified into a unit, which is mounted on the cartridge C. In the state that cartridge C is mounted to the main assembly A of the apparatus, the cartridge side transmitting portion 23 faces and contacts a transmitting portion 14 of the main assembly side of the apparatus.

By this, the main assembly controller 24 provided in the main assembly A of the apparatus and the memory 22 provided in the memory 22 are electrically communicatable with each other through the transmitting portions 14 and 23, thus enabling the main assembly controller 24 to read the content of the memory 22 and to write information in the memory 22.

The main assembly controller 24 reads the discriminative information stored in the memory 22 to discriminate or determine the kind of the cartridge C mounted to the main assembly A of the apparatus.

In the foregoing example, the cartridge side transmitting portion 23 and the main assembly side transmitting portion 14 are contacted to each other, by which the data communication is enabled for the read and writing. However, a non-contact type data communication may be employed using electromagnetic wave. In such a case, an antenna member (unshown) for electromagnetic radiation communication is provided on each of the cartridges C and the main assembly A of the apparatus.

The cartridge side transmitting portion 23, the main assembly side transmitting portion 14 and the main assembly controller 24 constitute control means for effecting the reading and writing of the information for the memory 22.

The capacity of the memory 22 is determined so as to be enough to store the information of the cartridge use amount and the information of cartridge characteristic value and so on. The memory 22 may be a normal semiconductor electrostatic memory element, and there is no particular limitation.

(3) Manual Density Change Control:

Referring to FIG. 3 which is a block diagram of a control system, designated by reference numeral 20 is an operating portion (operation panel) of the host computer B (external device). Designated by 21 is a main assembly operating portion (operation panel) of the main assembly A of the apparatus. By operating an image density change input portion 20a or 21a provided in the main assembly operating portion 21, the desired image density can be manually inputted in the main assembly controller 24 which is the image density changing device. Therefore, when the user desires to output an image with a certain density, the manual density change can be done. More particularly, the main assembly controller 24 has a default reference image density, and changes the DC voltages of the charging bias and the developing bias in accordance with the changed image density and the result of the discrimination using the kind discrimination means for a mounted cartridge so as to provide the desired image density.

However, if the developing bias DC voltage alone is changed in order to change the development contrast, there is a possibility that difference (back contrast) between the developing bias DC voltage and the DC voltage of the charging bias is too small with the result of production of foggy background. However, if the developing bias DC voltage alone is changed in order to change the development contrast, there is a possibility that difference (back contrast) between the developing bias DC voltage and the DC voltage of the charging bias is too small with the result of production of foggy background. In view of this, it is preferable to change the DC voltage of the charging bias as well as the DC voltage of the developing bias to provide a proper back contrast.

This will be described with an example in which the back contrast of 100V-200V is the range with which the fog is not remarkable. In this case, the default settings of the bias voltages are as in the first line of Table 1-1. Here, it is assumed that development contrast is increased, only by changing the development DC voltage, namely, the setting is changed toward the high density side. Then, the back contrast is as small as 60V, and therefore, the toner is deposited on the white background portion (dark potential portion) with the result of production of the fog.

For this reason, it is preferable that charging DC voltage as well as the development DC voltage is changed to provide the back contrast of 100V-200V.

TABLE 1-1

| | Charging | back | dev. DC | dev. | light |
|---|---|---|---|---|---|
| | DC vol. | contrast | voltage | contrast | potential |
| Default | −560 V | (130 V) | −430 V | (300 V) | −130 V |
| (1) | −560 V | (60 V) | −500 V | (370 V) | −130 V |
| (2) | −650 V | (120 V) | −530 V | (363 V) | −167 V |

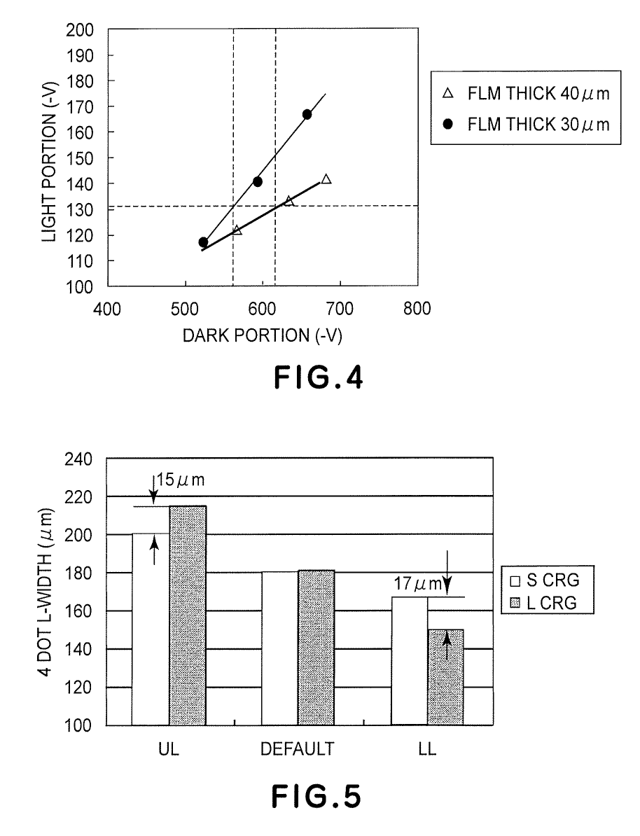

The description will be made as to the latent image property of the drum depending on the thickness (film thickness) of the photosensitive layer of the drum 1. The electrostatic capacity of the drum 1 is different depending on the film thickness of the photosensitive layer. Therefore, when the drum having a dark portion potential (−600V, for example) is exposed to a predetermined amount of light, the light portion potential is different depending on the film thickness of the drum. FIG. 4 shows a change of the light portion potential vs. the dark portion potential when the film thickness of the photosensitive layer is 40 μm and 30 82 m with the same sensitivity. The illuminance on the drum surface indicative of the exposure amount is 2.7 mJ/m2.

Thus, if the dark portion potential is the same, the light portion potential is different since the film thickness of the photosensitive layer is different. In view of this, in the default setting, the DC voltage of the charging bias is adjusted so that light portion potential is the same irrespective of the film thickness of the photosensitive layer. By this, with the default setting, the same density and the same line width can be provided by the same light portion potential and the same DC voltage of the developing bias even if the film thickness of the photosensitive layer is different.

The dark portion potential is the potential provided by charging the surface of the drum by the charging means. In this embodiment, it corresponds to the DC voltage applied to the charging roller 2 through the AC contact charging type charging process.

More particularly, the charging bias DC voltage is −610V when the film thickness of the photosensitive layer is 40 μm and is −560V when it is 30 μm so as to provide the light portion potential of −130V.

As shown in FIG. 4, the inclination of the light portion potential relative to the dark portion potential is different if the film thickness of the photosensitive layer is different.

Therefore, in the case that density change is effected by the density changing device with the reference value of the default setting, it is preferable to change the charging DC voltage as well as the development DC voltage from the standpoint of prevention of the fog. Therefore, the difference in the film thickness of the photosensitive layer results in the difference in the light portion potential and then the difference in the development contrast.

Tables 1-2 and 1-3 are related to comparison examples not using the present invention. Table 1-2 represents an S cartridge (second cartridge) including a photosensitive layer (second photosensitive layer) having a film thickness of 30 μm; Table 1-3, an L cartridge (first cartridge) including a photosensitive layer (first photosensitive layer) having a film thickness of 40 μm. The density change operations are carried out with the S cartridge and the L cartridge. When the density change is carried out as shown in Table 1-2 and Table 1-3 with the line width provided by 4 dots, the development DC voltage is kept constant irrespective of the kind of the cartridge relative to the default setting (standard value setting). In such a case, it is necessary to change the charging DC voltage in accordance with the change of the development DC voltage to avoid remarkable fog. As to the upper limit value setting of the image density, because of the property of FIG. 4, the light portion potential is different between the S cartridge and the L cartridge, and therefore, the difference of 20V (330V in the S cartridge and 350V in the L cartridge) results in the development contrast although the development DC voltages are the same. In such a case, the situation is as shown in FIG. 5 where as to the cartridges which are usable with the same main assembly A of the apparatus, the line widths are different by approx. 15 μm upon density change, depending on the kind of the used cartridge (S cartridge or L cartridge).

Even if the development DC voltage and light portion potential are made the same irrespective of the kind of the cartridge, the development contrasts are the same irrespective of the kind of the cartridge, but the back contrasts are significantly different depending on the kind of the cartridge. Therefore, it has been difficult to set the back contrast so as to avoid the fog irrespective of the kind of the cartridge. The back contrast is a difference between the dark portion potential and the developing bias DC voltage, that is, the difference between the charging bias DC voltage and the developing bias DC voltage.

TABLE 1-2
(S cartridge)

| | Charging | back | dev. DC | dev. | light |
|---|---|---|---|---|---|
| | DC vol. | contrast | voltage | contrast | potential |
| Upper limit | −650 V | (150 V) | −500 V | (330 V) | −170 V |
| Default | −560 V | (130 V) | −430 V | (300 V) | −130 V |
| Lower limit | −470 V | (110 V) | −360 V | (265 V) | −95 V |

TABLE 1-3
(L cartridge)

| | Charging | back | dev. DC | dev. | light |
|---|---|---|---|---|---|
| | DC vol. | contrast | voltage | contrast | potential |
| Upper limit | −700 V | (200 V) | −500 V | (350 V) | −150 V |
| Default | −610 V | (180 V) | −430 V | (300 V) | −130 V |
| Lower limit | −520 V | (160 V) | −360 V | (250 V) | −110 V |

Table 2 and Table 3 show the settings of image forming condition in this embodiment. When several kinds of cartridges having different photosensitive layer film thicknesses of the drum are selectively mounted to the same main assembly A of the apparatus, the same density and the same line width are provided when the image density is changed to the same degree as well as when the default setting is used. To accomplish this, it is preferable that charging DC voltage and the developing bias DC voltage are optimized so as to be immune to the difference in the photosensitive layer film thickness.

On the basis of the foregoing analysis, the amounts of changes of the developing bias DC voltage from the default setting are made different so as to provide the same development contrasts while keeping the back contrast within the range 100V-200V in which the fog is not remarkable, as shown in Table 2 (second cartridge, S cartridge) and in Table 3 (first cartridge, L cartridge) . It is preferable that contents of Tables 2 and 3 are stored in the memory of the main assembly of the apparatus, so that memory 22 of the cartridge can store the information for selecting the information (information of Tables 2 and 3) which include the default setting and the information including the upper limit value and lower limit value and the information required for the predetermined value setting. The default setting may be stored in the memory 22 in place of the memory provided in the main assembly. By using the memory 22 having enough capacity, the memory 22 may store the contents of the Tables 2-3.

TABLE 2
(S cartridge)

| | Charging | back | dev. DC | dev. | light |
|---|---|---|---|---|---|
| | DC vol. | contrast | voltage | contrast | potential |
| Upper limit | −670 V | (150 V) | −520 V | (350 V) | −170 V |
| Default | −560 V | (130 V) | −430 V | (300 V) | −130 V |
| Lower limit | −450 V | (110 V) | −340 V | (250 V) | −90 V |

TABLE 3
(L cartridge)

| | Charging | back | dev. DC | dev. | light |
|---|---|---|---|---|---|
| | DC vol. | contrast | voltage | contrast | potential |
| Upper limit | −700 V | (200 V) | −500 V | (350 V) | −150 V |
| Default | −610 V | (180 V) | −430 V | (300 V) | −130 V |
| Lower limit | −520 V | (160 V) | −360 V | (250 V) | −110 V |

An amount of the change from the default set point of the developing bias DC voltage to the upper limit value of the density or the lower limit value of the density is 90V in the S cartridge (in Table 2) and is 70V in the L cartridge (Table 3).

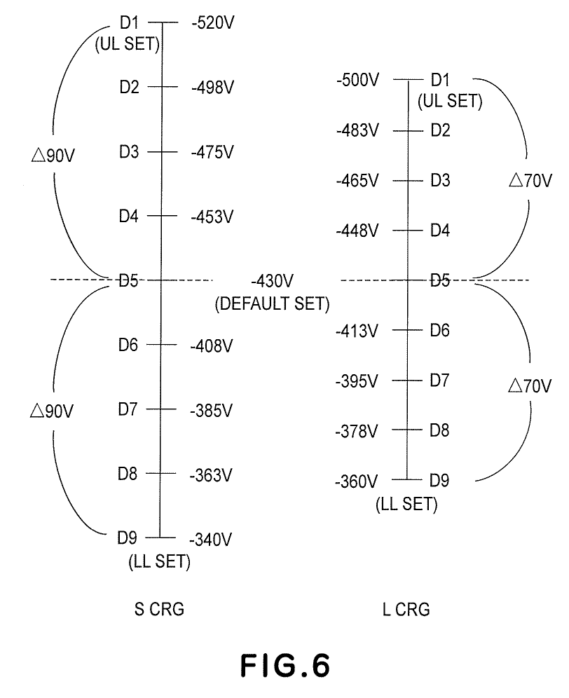

In order to accomplish the selectivity of an plurality of step densities within the range between the upper limit value and the lower limit value of the density, as shown in FIG. 6, the developing bias DC voltage can be changed in 9 steps with the uniform incrementation or decrementation from the default setting within the range between the upper limit value and the lower limit value. D1 represents the upper limit value setting of the density D5 represents the default (standard value) setting; and D9 represents the lower limit value setting of the density.

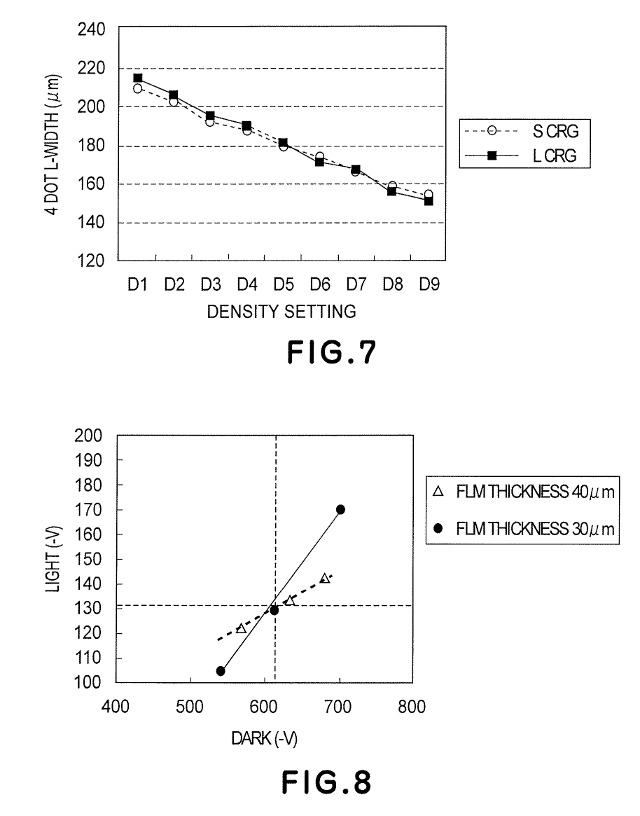

The density was changed, and the advantageous effects of the present invention were confirmed with the line width of 4 dot. The results are shown in FIG. 7, which shows that equivalent changes in the line width in the S cartridge and the L cartridge were provided.

As to the half-tone density, similarly to the line width, the similar reflection density values are provided by the S and L cartridges.

Even when the film thicknesses of the photosensitive layers are different, and the sensitivities of the drum are the same, the charging and developing bias settings can be the same when the default setting time is used, as shown in FIG. 8.

Therefore, it is not necessary for the user to discriminate the film thickness of the photosensitive layer in the cartridge, and to set the bias voltage correspondingly to the discriminated film thickness. More particularly, when the center setting of the density is changed from the default setting, the charging bias DC voltage is not changed, and only the developing bias DC voltage is changed independently, both for the S cartridge and L cartridge, and therefore, the control system can be simplified.

Thus, as shown in FIG. 8, the sensitivity is adjusted by using different film thicknesses of the charge generation layers in the photosensitive layer so that substantially the same light portion potential is provided for the predetermined dark portion potential.

The bias settings of the upper limit value and the lower limit value of the density are set as shown in Table 4 to change the density away from the default setting.

TABLE 4

| | | charging | dev. | light |
|---|---|---|---|---|
| S CRG | L CRG | DC | DC | potential |
| upper limit | | −700 V | −520 V | −170 V |
| | lower limit | −700 V | −500 V | −150 V |
| | Default | −610 V | −430 V | −130 V |
| | lower limit | −510 V | −360 V | −110 V |
| upper limit | | −510 V | −340 V | −90 V |

By the control shown in Table 4, the equivalent density change and equivalent change of the line width in both of the S cartridge and the L cartridge are provided, similarly to FIG. 7 described hereinbefore.

As described in the foregoing, when the image density set level is changed from the default setting, the amount of the change of the developing bias DC voltage are different between the cartridges including the photosensitive layers having different film thicknesses. When the image density set level set in the image forming apparatus is changed by the user away from the standard value (default value), the amount of the change of the developing bias DC voltage is different depending on the results of discrimination by the cartridge kind discriminating means. In this manner, the same image quality can be provided irrespective of the kinds of the cartridges.

### Embodiment 2

In this embodiment, selection information for selecting the development DC voltage when the image density set level is changed from the standard value.

In Embodiment 1, the control is different depending on the cartridges having different photosensitive layer film thicknesses. In this Embodiment 2, the control is made different depending on the information selecting the developing condition such as the state of use of the cartridge C. The cartridge C is provided with a memory element 22, and the amount of change of the developing bias DC voltage when the density adjustment from the default setting is effected is adjusted in accordance with the number of produced prints. By combining Embodiment 1 and Embodiment 2, the control can be made different depending on the state of use of the cartridge according to Embodiment 2, for the cartridges having different photosensitive layer film thicknesses.

The memory 22 provided in the cartridge C stores information for setting the image forming condition (process condition) relating to the changeable density setting of the cartridge, and on the basis of the information, image quality variations due to the differences in the history of use of the cartridge can be prevented, thus assuring the stable image quality.

The memory 22 stores the selection information for selection from pieces of setting information of amounts of change of the developing bias DC voltage when the density set level of the output image is changed from the standard value (default value). When the density set level is changed from the standard value, the main assembly controller 24 changes the developing bias DC voltage with the amount of change being different in accordance with the selection information stored in the memory 22 of the cartridge C mounted in the main assembly A of the apparatus, more particularly the use amount information relating to the use amount of the cartridge.

The memory 22 stores the information relating to the history of use of the cartridge C as the use amount information of the cartridge. The main assembly controller 24 sets the developing bias DC voltage when the density is changed on the basis of the selection information of the memory 22, namely, the information relating to the history of use of the cartridge. The information for selecting the amount of change of the developing bias DC voltage when the density set level is changed from the standard value (default value) is stored in the memory of the main assembly of the apparatus. It is preferable that memory of the main assembly of the apparatus stores the development DC voltage at the time when the density set level is the standard value and/or the development DC voltage at the time when the density set level is at a different level.

In the memory 22, the information about the integrated use amount of the cartridge C is stored at proper timing. The use amount information of the cartridge stored in the memory 22 may be any if it can be discriminated by the main assembly A of the apparatus Examples of such information include integrated rotation time period of a unit or units such as the drum 1, the charging roller 2, the developing sleeve 5 and so on, and the integrated bias voltage application time period to the developing sleeve 5 or the like. The examples further include the remaining toner amount, the integrated number of prints, the integrated number of dots formed on the drum, the integrated laser light emission time period of exposing the drum. Examples yet further include the film thickness of the photosensitive layer, a combination of two or more of these values with weighting, and a parameter obtained from a value of values.

Furthermore, a cartridge characteristic value indicative of a property of a cartridge at the time of delivery from the plant of the cartridge manufacturer is a parameter to be used when the process condition is changed, and is stored in the memory 22 before the delivery from the plant.

Examples of the parameter include a manufacturing lot of the drum, an electrical characteristic value of the charging roller, a contact pressure of the cleaning blade and the like.

On the basis of the information stored in the memory 22, the process condition or conditions are controlled by the main assembly controller 24. More particularly, the main assembly controller 24 reads the information in the memory 22 of the cartridge C mounted to the main assembly A of the apparatus. The main assembly controller 24 effects processing using such information, and changes the process condition or conditions on the basis of the result of the processing.

In this embodiment, the control operation is carried out in the following manner using the information relating to the use amount of the cartridge.

1) the time period in which the cartridge C is driven in the main assembly of the apparatus is stored in the memory 22.

The contact pressure of the cleaning blade 10 to the drum 1, coefficient information of an operational expression determined by the electrical property of the charging roller 2, and threshold information indicative of the process condition switching timing, are stored in the memory 22.

3) the use amount of the cartridge C (the use amount of the drum 1, for example) are calculated on the basis of the drive time and the coefficient information stored in the memory 22 in the main assembly A of the apparatus. The comparison is made between the calculated value and the use amount threshold information which is predetermined by the property of the photosensitive material of the drum 1 and which is stored in the memory 22. The process condition is changed when the calculated value reaches the threshold.

Here, the threshold information which is stored in the memory 22 may be provided in a multiple stage, and the switching of the charging/developing bias may be carried out a plurality of times. By this, a stabilized light portion potential can be provided throughout the use period of the drum 1, so that high image quality (stabilization of image quality) can be provided. In addition to the information relating to the process condition, the threshold information therefor may be stored in the memory 22.

Reference to FIG. 3, more detailed description will be made. In this embodiment, the drum use amount information calculated on the basis of the drum rotation time is used as the information relating to the cartridge use amount. It corresponds to the use amount of the drum processed on the basis of damage index of the drum which is disclosed in Japanese Patent No. 3285785.

The main assembly controller 24 comprises various function portions including a memory element 13 for data storing, a controller 25, a processing portion 26, a drum rotation instructing portion 27, a charging bias application time detection portion 28, a high voltage controller 29 or the like.

In the state that cartridge C is set in the main assembly A of the apparatus, the cartridge side transmitting portion 23 is in face contact to the transmitting portion 14 of main assembly side of the apparatus. By this, the main assembly controller 24 in the main assembly A of the apparatus and the memory 22 of the cartridge C are electrically contacted with each other through the transmitting portions 14 and 23 to enable the main assembly controller 24 to read the content of the memory 22 and to write information in the memory 22.

The memory 22 of the cartridge C stores in the following manner in the memory areas 31-34:

The cartridge drive time information T,

The drum use amount operational expression coefficient which is a coefficient for weighting in the calculation of the drum use amount information φ,

Drum use amount threshold information α,

Information for selecting tables for setting the image forming condition correspondingly to the drum use amount threshold information, or the like.

These pieces of information are required in this embodiment to select the development DC voltage when the image density set level is changed from the standard value by the density changing device.

The threshold information α for the drum use amount and the operational expression coefficient information φ for the drum use amount are stored in the memory 22 before the cartridge C is delivered from the plant.

These values are dependent on the drum sensitivity, the drum material, the contact pressure of the cleaning blade to the drum and the electrical property of the charging roller, and therefore, they are stored in the memory 22 of the cartridge C.

The description will be made as to the controlling operation in this embodiment.

When the main assembly controller 24 of the main assembly A of the apparatus receives a printing signal, the drum rotation instructing portion 27 drives the cartridge C to start the image forming process operation. Then, the drum use amount is calculated in the following manner:
D=A+B×φ,

Where B is integrated drum rotation time as instructed by the drum rotation instructing portion 27 which is the cartridge drive time information T.

A is integrated charging bias application time data as detected by the charging bias application time detection portion 28, and

φ is a weighting coefficient read out of the memory 22.

The calculation is carried out by the processing portion 26, and is integrated and stored in the main assembly memory 13 for the main assembly data storing.

The integrated and stored drum use amount D is compared with the threshold α in the memory 22 by the processing portion 26. When the result of the comparison indicates that drum use amount D becomes larger than the threshold α, the controller 25 feeds a control signal to the high voltage control circuit portion 29 to change the DC voltage of the charging bias of the high voltage source to be applied to the charging roller 2. In addition, the DC voltage of the developing bias of the high voltage source to be applied to the developing sleeve 5 is changed.

The data of the drum rotation time and the data of the charging bias application time are stored in the memory 22 at proper timing, and the processing of the data of the drum use amount is carried out at proper timing when the drum 1 stops.

In this embodiment, the use is made with a cartridge C having a toner capacity of 10000 sheets (5% printing) and having a photosensitive layer film thickness of 40 μm.

The wearing speed of the drum due to the image forming operations was 1 μm/1000 sheets in either of S and L cartridges in a one-sheet/job mode.

The drum use amount per print is calculated from the data,

A=10 (integration of the charging bias application time data)

B=5 (integration of the drum rotation time) and.

φ=2 (weighting coefficient).

The result is the drum use amount D=20 per one print.

The threshold information α and the setting table for the charging/developing bias are determined as shown in Table 5, on the basis of the wearing amount of the drum resulting from the number of image forming operations. In this embodiment, the table as shown in Table 5 is stored in the main assembly memory 13. The main assembly memory 13 stores an plurality of setting information data for setting the development DC voltage when the density set level is changed from the standard value to the level (the upper limit value or lower limit value of density, for example).

TABLE 5

| | | charging | dev. | light |
|---|---|---|---|---|
| Threshold | | DC | DC | potential |
| α1 = 0 | up. limit | −700 V | −500 V | −150 V |
| | default | −610 V | −430 V | −130 V |
| | low. limit | −520 V | −360 V | −110 V |
| α2 = 100000 | up. limit | −685 V | −510 V | −160 V |
| | default | −580 V | −430 V | −130 V |
| | low. limit | −475 V | −350 V | −100 V |
| α3 = 200000 | up. limit | −670 V | −520 V | −170 V |
| | default | −560 V | −430 V | −130 V |
| | low. limit | −450 V | −340 V | −90 V |

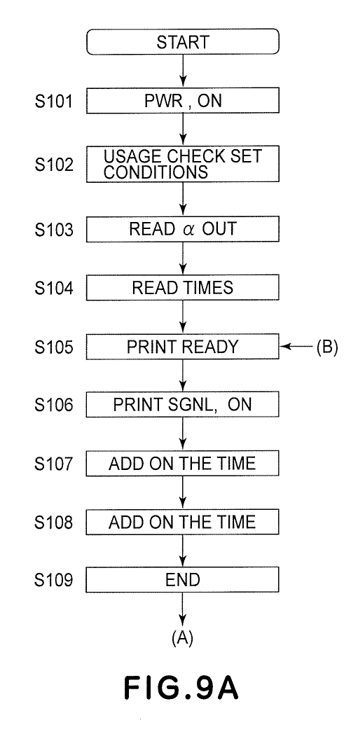

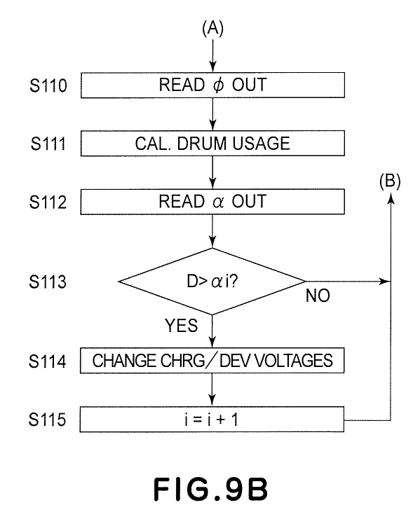

Referring to FIG. 3 which is a block diagram the control system and which is a flow chart of FIGS. 9A-9B, the operations will be described.

START: control start.

S101: to actuate voltage source of the main assembly A of the apparatus.

S102: to read information indicative of whether or not the cartridge C mounted in the main assembly of the apparatus is an unused one, from a storing region m05 of the memory 22. If it is an unused one, the information is renewed so as to indicate “used”. In addition, the setting information c for setting the process condition in accordance with the information for selecting the process condition at the time of start of use is read out of a storing region m06 of the memory 22. The information c is provided by the data in the Table 5 as the case of α1=0, and in such a case, the process condition is set to that corresponding to the information c. The information c is stored in the memory 13 of the main assembly A of the apparatus the value for the data at the time of start of use of the cartridge.

S103: to read threshold information αi stored in a storing region m07 of the memory 22, by the main assembly controller 24, and the read threshold information stored in the memory 13 of the controller 24 (the initial value of i is 1).

S104: to read, from storing regions m02 and m03, the information indicative of integrated drum rotation time and charging bias application time by then.

S105: thereafter, the image forming apparatus placed in the state of print ready (capable of receiving printing signal) and waits for a printing signal.

S106: actuates printing signal (ON).

S107: the drum time detection function portion of the drum rotation instructing portion 27 starts to count the rotation time and integrates on the drum rotation time read out of the memory 22.

S108: the charging bias application time detection portion 28 starts to count the charging bias application time and integrates on the charging bias application time read out of the memory 22.

S109: completion of printing.

S110: to read the weighting coefficient φ out of the storing region m04 of the memory 22.

S111: the processing portion 26 calculates the drum use amount D on the basis of the drum rotation time and the charging bias application time integrated at the steps S107 and S108 and on the basis of the weighting coefficient p read out of the memory 22.

S112: to read the threshold information αi from the memory 13 of the main assembly controller 24.

S113: the processing portion 26 compares the drum use amount data D with the drum use amount operational expression threshold αi. In other words, the discrimination is made as to whether or not D>αi. If the result of discrimination is affirmative, the operation goes to S115, and if not, the operation returns to step S105 where the control operation is repeated.

S114: to read, from the storing region m08 of the memory 22, a table selection value d (setting table for α2=100000 in Table 5) corresponding to the drum use amount operational expression threshold, so that the process conditions (charging and development DC voltages) is switched. At step S102, the information in the memory 13 is overwritten by the d value and is stored in the memory 13 (the memory 13 is overwritten each time the set point is switched.

S115: i=i+1, and the operation returns to the step S105.

The comparison will be made as to the line width between when the above-described control is carried out and when the change amount (70V) of the developing bias DC voltage is constant (comparison example, namely, conventional) . The used line width is 4 dot (600 dpi) at each of the default setting, the density of upper limit setting and the density of lower limit setting in one-sheet/job at 2% printing ratio.

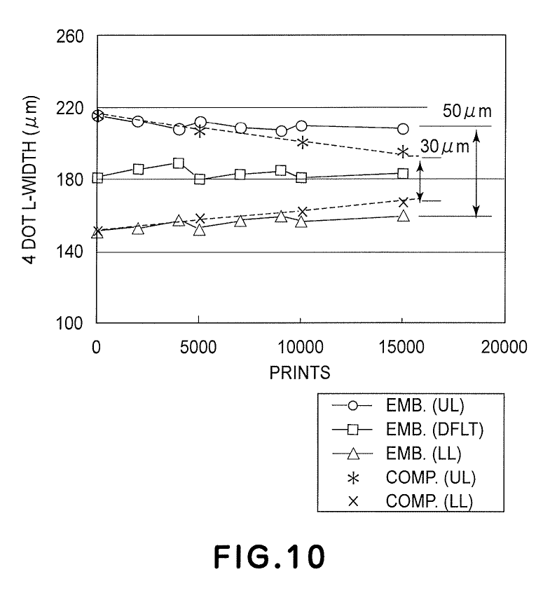

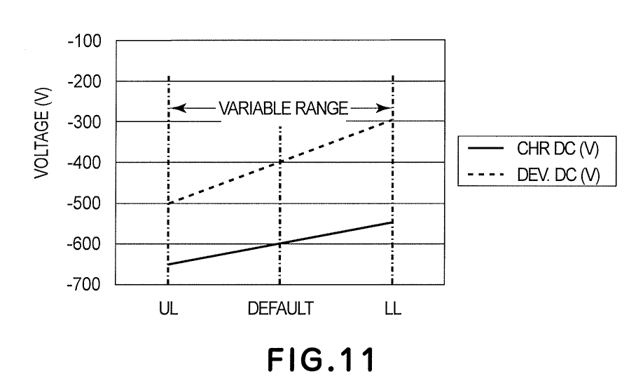

FIG. 10 shows the result, wherein the amount of change of the line width at the upper and lower limit densities decreases with the number of prints in the comparison example, whereas the line width at the upper and lower limit densities is stabilized, so that high image quality images are produced without the fog for a long term.

As described in the foregoing, in the case that a plurality of kinds of cartridges are used, or in accordance with the use amount of the cartridge, the following control operation is carried out: When the image density is changed from the predetermined standard value density setting preset in the image forming apparatus, the developing bias DC voltage is changed by a different amount depending on the kind or the use amount. By this, the variation of the image quality, particularly the image density and the line width, due to the difference of kind, and the image quality can be stabilized throughout the service life from the start of use.

According to the embodiments of the present invention, even when an plurality of kinds of process cartridges having different photosensitive layer film thicknesses of the image bearing member images are selectively mounted to the image forming apparatus, the variation in the image quality due to the difference of the kind can be avoided, and the stable image quality can be provided.

In addition, on the basis of the information stored in the memory medium provided in the process cartridge, the difference in the image quality attributable to the difference in the history of use of the cartridge can be compensated, so that stabilized image quality can be maintained throughout the lifetime of the cartridge. In other words, even when the cartridges having different history of use, namely, the different photosensitive layer film thickness of the image bearing member image or the like, are used, the stabilized image quality can be provided and maintained throughout the lifetime of the cartridge.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 347150/2006 filed Nov. 30, 2005 which is hereby incorporated by reference.

1. An image forming apparatus comprising:
an image bearing member including a first photosensitive layer having a first thickness provided in a first cartridge detachably mountable to a main assembly of said image forming apparatus or including a second photosensitive layer having a second thickness provided in a second cartridge detachably mountable to said main assembly of said image forming apparatus;
a developer carrying member for carrying a developer to develop with a developer an electrostatic image formed on said image bearing member;
a voltage source for applying a development DC voltage to said developer carrying member;
a density changing device for changing a density of the image by changing the development DC voltage, wherein when said density changing device changes a density set level from a standard value to a changed value, an amount of the change of the development DC voltage is different between when said first cartridge is used and when said second cartridge is used.

2. An apparatus according to claim 1, further comprising discrimination means for discriminating whether said first cartridge or said second cartridge is mounted to said image forming apparatus.

3. An apparatus according to claim 2, wherein said cartridge comprises a memory medium for storing information indicative of a kind ofthe cartridge. and said discriminating means discriminates the information.

4. An apparatus according to claim 3, wherein said memory medium stores information usable for selection of the development DC voltage when said density changing device changes said density set level.

5. An apparatus according to claim 3, wherein an image forming condition for said image bearing member when the density set level is the standard value and an image forming condition for said image bearing member when the density set level is the changed value, are controlled on the basis of the information.

6. An apparatus according to claim 1, wherein the changed value is at least one of an upper limit set point of the image density and a lower limit set point of the image density.

7. An apparatus according to claim 1, wherein the density set level is the standard value, the development DC voltage is the same irrespective of whether said first cartridge or said second cartridge is used.

8. An apparatus according to claim 7, further comprising a charger for electrically charging said image beating member. wherein a difference between the charging DC voltage applied to said charger and the development DC voltage when the density set level is an upper limit set point of the image density is larger than a difference between the charging DC voltage applied to said charger and the development DC voltage when the density set level is the standard value.

9. An apparatus according to claim 1, wherein the density changing device is manually operable.

10. An apparatus according to claim 1, wherein said cartridge contains said developer carrying member.

11. An apparatus according to claim 10, wherein a capacity of the developer of said second cartridge is smaller than a capacity of the developer of said first cartridge.

12. An image forming apparatus comprising:
an image bearing member provided in a cartridge detachably mountable to a main assembly of said image forming apparatus;
a developer carrying member for carrying a developer to develop with a developer an electrostatic image formed on said image bearing member;
a voltage source for applying a development DC voltage to said developer carrying member;
a density changing device for changing an image density by changing the development DC voltage;
a memory medium, provided in said cartridge, for storing selecting information usable for selection of the development DC voltage when an image density set level is changed from a standard value to a changed value,
wherein when said density changing device changes the density set level from the standard value to the changed value, the development DC voltage is controlled on the basis of the information.

13. An apparatus according to claim 12, wherein the main assembly of said image forming apparatus a memory medium storing a plurality of pieces of setting information for setting the development DC voltage when the density set level is changed, and the setting information is selected therefrom when the density set level is changed to the changed level in accordance with the selecting information.

14. An apparatus according to claim 12, wherein said selecting information includes use amount information relating to a use amount of said cartridge.

15. An apparatus according to claim 14, wherein said selecting information includes use amount information relating to a use amount of said cartridge, and when the use amount information reaches the threshold, the development DC voltage is variably controlled.

16. An apparatus according to claim 14, wherein the use amount information includes an integrated rotation time of said image bearing member.

17. An apparatus according to claim 14, wherein said cartridge comprises a charger for charging said image bearing member, and the use amount information includes an integrated time in which said charger is supplied with a voltage.

18. An apparatus according to claim 12, wherein the image forming condition for said image bearing member when the density set level is the standard value and the image forming condition for said image bearing member when the density set level is the changed value, are controlled on the basis of the selecting information.

19. An apparatus according to claim 12, wherein the changed value is at least one of an upper limit set point of the image density and a lower limit set point of the image density.

20. An apparatus according to claim 12, wherein when the density set level is the standard value. the development DC voltage is the same irrespective of the selecting information.

21. An apparatus according to claim 19, further comprising a charger for electrically charging said image bearing member, wherein a difference between the charging DC voltage applied to said charger and the development DC voltage when the density set level is an upper limit set point of the image density is larger than a difference between the charging DC voltage applied to said charger and the development DC voltage when the density set level is the standard value.

22. An apparatus according to claim 12, wherein the density changing device is manually operable.

23. An apparatus according to claim 12, wherein said cartridge contains said developer carrying member.
